(19) United States
(12) Patent Application Publication
(10) Pub. No.: US 2013/0133241 A1
(43) Pub. Date: May 30, 2013

(54) In-Line Fish Teaser

(71) Applicant: Clay S. Barker, Plantation, FL (US)

(72) Inventor: Clay S. Barker, Plantation, FL (US)

(21) Appl. No.: 13/687,108

(22) Filed: Nov. 28, 2012

Related U.S. Application Data
(60) Provisional application No. 61/563,950, filed on Nov. 28, 2011.

(51) Int. Cl. A01K 97/02

(52) U.S. Cl. CPC A01K 97/02
USPC 43/44.9

(57) ABSTRACT

A trolling teaser having a tubular hull having a circumference defined by a wall and an end cap at each end of the tubular hull, each of the end caps having a center opening to receive a fishing line, such that the fishing line passes through each of the center openings and through said tubular hull and each of the end caps having a thickness and the outer edge of each of the end caps including a groove and an o-ring within said groove for contacting the inner wall of the tubular hull when the end cap is within the tubular hull. One of the end caps having a second opening for receiving a first tube and a third opening for receiving a second tube, and the first tube and the second tube disburses fluids from within the tubular hull and the fluid is a fish oil.

### PRIORITY

This application claims the benefit and priority to U.S. Provisional Patent Application Ser. No. 61/563,950 filed Nov. 28, 2011 entitled In Line Fish Teaser, as if the same were incorporated herein in its entirety.

### BACKGROUND OF THE INVENTION

1. Field of the Invention

The present invention is an apparatus for use in fishing to attract fish.

2. Description of the Related Art

Trolling teasers are used to attract many species of fish. They are attached by a line from a moving vehicle typically a boat and the teasers are dragged or pulled through the water.

### BRIEF SUMMARY OF THE INVENTION

The present invention is a fish teaser, which is used to attract fish. The apparatus is a container to hold fish oil that is part of the fishing line between the hook and the rod and reel. The oil is disbursed slowly from the container while the container and hook are trolled behind a boat. Alternatively the apparatus can be used with or without oil and having one or more balls within the container that make noise by contacting one another and/or the inner walls of the container and its end caps, where the noise attracts fish.

### BRIEF DESCRIPTION OF THE DRAWINGS

FIG. 1 is a side view of the container of the present invention showing the arrangement of lines and tubes with portions within the container shown in dotted lines.

FIG. 2. Is a cross section view taken along line A-A from FIG. 1 but shown without the lines and tubes.

FIG. 3. Is a front view of the front cap of the invention but shown without the lines and tubes.

FIG. 4. Is a rear view of the rear cap of the invention but shown without the lines and tubes.

FIG. 5. Is a rear view of an alternate embodiment of the rear cap of the invention but shown without the lines and tubes.

FIG. 6. Is a rear view of the rear cap of the invention when the cap is rotated approximately 45 degrees to the left but shown without the lines and tubes.

FIG. 7. Is a rear view of the rear cap of the invention when the cap is rotated approximately 45 degrees to the right but shown without the lines and tubes.

FIG. 8. Is a front view of an alternate embodiment of the front cap of the invention but shown without the lines and tubes.

FIG. 9 is a perspective side view of a boat, a fishing pole having a line and a hook apparatus. On the line is the present invention shown below the water surface.

### DETAILED DESCRIPTION OF THE PREFERRED EMBODIMENT

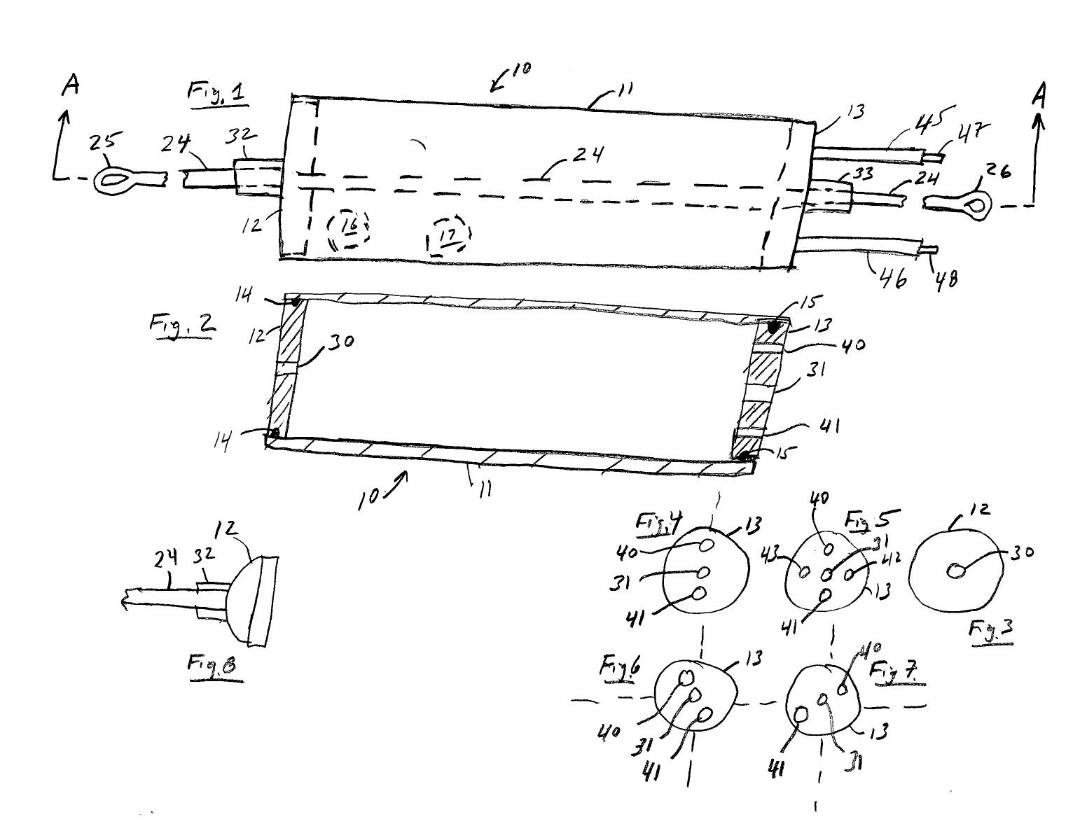

Referring to FIG. 1. The in line teaser 10 of the present invention includes a canister 11, which is elongated and cylindrical in shape, though alternate shapes could be used e.g. square, rectangular. The tubular canister 11 has a front cap 12 and a rear cap 13. Caps 12 and 13 either screw into canister 11 or can fit there-within by a friction fit. Since the canister is intended to contain a fish oil, caps 12 and 13 should fit leak tight and therefore may have a front o-ring 14 and rear o-ring 15 or a washer to fit between the cap and the wall of canister 11. Canister 11 can be made of any material.

A pair of balls 16 and 17 are shown in phantom within canister 11. When the canister is filled with fish oil, such as menhaden fish oil, the balls 16 and 17 stir the oil supply within the canister 11 as well as make noise by hitting one ball 16 against the other ball 17, hitting the inner side walls of canister 11, the end caps 12 and 13 causing a noise, which noise attracts fish. More than two balls can be used to make noise. Further one or more balls can be used to make noise within the canister 11 without having fish oil within the canister 11.

A fishing line 20, extending from a pole 21 typically held by a fisherman on a boat 22 trolling through water 23. A leader line 24 extends through canister 11 from one end to the other. Line 24 has front eye 25 and a rear eye 26. Canister 11 is place in the line 21 by attaching said line 20 to eye 25 and to eye 26, so that canister 11 is between the pole 21 and hook 27 as shown in FIG. 9.

Line 24 is threaded through canister 11, typically first through cap 12 at opening 30 and through cap 13 at opening 31. Line 24 fits snuggle through openings 30 and 31 such that no oil within container 11 will leak out thought said openings 30 and 31 when said line 24 is in place as described herein. Additionally a front break 32 in the form of a short piece of tubing that tightly fits around line 24 keeps canister 11 from sliding forward along line 24 and similarly a rear brake 33 keeps canister 11 from sliding rearwardly along line 24. Thus canister 11 is held in place securely between eyes 25 and 26.

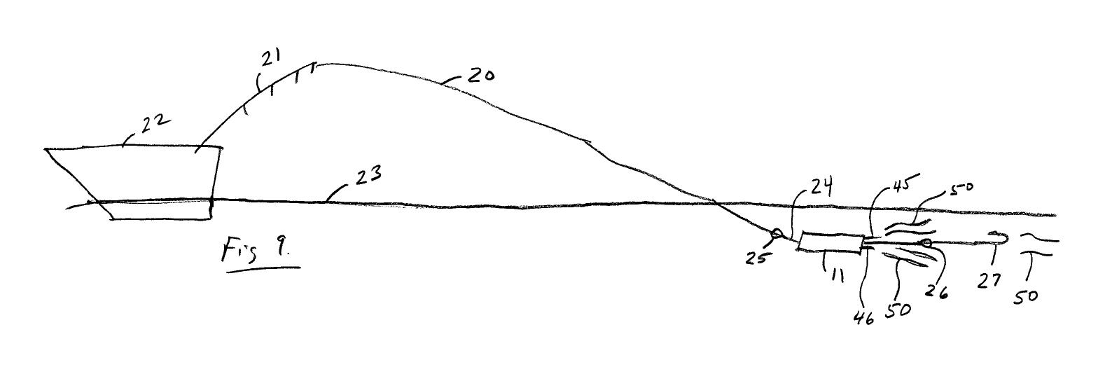

Rear cap 13 includes one or more openings 40, 41, 42 and 43. These openings extend through cap 13 and are designed to discharge the fish oil within canister 11. A tube 45 extends from opening 40 and a second tube 46 extends from opening 41. Additional tubes would extend from openings 42 and 43 as shown in the FIG. 5 embodiment. Each tube, e.g. tube 45 and tube 46 referring to FIG. 1 has a plug 47 and 48 which securely fits within the respective tube to prevent the fish oil from passing from canister 11.

An alternate design for front cap 12 is shown in FIG. 8 where the cap 12 has a dome cross sectional shape. In a preferred embodiment canister 11 has an approximate diameter of 1 inches and a length of about 6 inches, though the diameter could be as small as inch and as great as 3 inches or more while the length could be as short as 3 inches or less and as long as 12 inches or more.

In use, canister 11 is placed in the line 20 by attaching said line 20 to eye 25 and then to eye 26 as known by fisherman. A hook or spoon with a hook 27 is at the end of line 20 to catch the fish. Then either front cap 12 or rear cap 13 is opened from canister 11 in order to fill the canister 11 with a menhaden fish oil 50. The canister 11 will be then be closed, sealing the oil 50 within the canister and one or more of plugs 47 and 48 are removed from tubes 45 and 46. For example in use, with one plug 45 removed there will be enough fish oil 50 dispersed from canister 11 so that a user can troll for 2 hours before there is no more fish oil. If both plugs 47 and 48 are removed then the fish oil 50 will be disbursed in about half the time, 1 hour. As can be seen in FIG. 9, the fish oil 50 is dispersed from the rear of canister 11 through one or both tubes 45 and 46 where the oil is dispersed in the water immediately behind the canister 11 and then the fish oil 50 is further disbursed through the water past the hook 27 and at the rear of hook 27 where fish will be attracted to the oil 50 disbursed through the water and attracted to spoon 27 as well as by the bobbing of the actual canister 11 in the water as well as the noise from balls 16 and 17.

Further in use, the arrangement of tubes 40, and 41 can act as a rudder, directing the canister in a particular direction as it is drawn through the water. In a vertical arrangement as shown in FIG. 4, the canister 11 proceeds generally straight, while as shown if FIG. 6, the canister 11 tends to steer itself to the right relative to the boat and as shown if FIG. 7, the canister 11 tends to steer itself to the left relative to the boat 22. FIG. 5 shows another oil disbursement pattern.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A trolling teaser comprising:
a tubular hull having a circumference defined by a wall;
an end cap at each end of said tubular hull, each of said end caps having a center opening to receive a fishing line, whereby said fishing line passes through each of said center openings and through said tubular hull.

2. A trolling teaser as set forth in claim 1, whereby each of said end caps have a thickness and the outer edge of each of said end caps includes a groove and an o-ring within said groove for contacting the inner wall of said tubular hull when said end cap is within said tubular hull.

3. A trolling teaser as set forth in claim 2, whereby one of said end caps has a second opening for receiving a first tube and a third opening for receiving a second tube.

4. A trolling teaser as set forth in claim 3, whereby said first tube and said second tube disburses fluids from within said tubular hull.

5. A trolling teaser as set forth in claim 4, whereby said fluid is a fish oil.
